(19) United States
(12) Patent Application Publication
(10) Pub. No.: US 2026/0015842 A1
(43) Pub. Date: Jan. 15, 2026

(54) TAP WITH HIDDEN ULTRASONIC TRANSDUCER

(71) Applicant: Diehl Aerospace GmbH, Ueberlingen (DE)

(72) Inventor: Sky HAUBRICH, Bad Vilbel (DE)

(73) Assignee: Diehl Aerospace GmbH, Ueberlingen (DE)

(21) Appl. No.: 19/269,549

(22) Filed: Jul. 15, 2025

(30) Foreign Application Priority Data
Jul. 15, 2024 (DE) 102024120126.6

(51) Int. Cl. E03C 1/05; F16K 31/06

(52) U.S. Cl. CPC E03C 1/057; F16K 31/06

(57) ABSTRACT

In a tap (2) for drawing water (6) therefrom with the aid of a hand (4), with a main body (8), wherein the main body (8) has an inlet end (10) with an inlet (12) for the water (6), and an outlet end (14) with an outlet (16) for the water (6), and extends along a course line (18) from the inlet end (10) to the outlet end (14), wherein the main body (8) has a wall (20) which surrounds a channel (22) for the water (6) extending inside the main body (8) and leading from the inlet (12) to the outlet (16), wherein the wall (20) has an outer visible surface (24) of the tap (2), with an ultrasonic transducer (30) for detecting the hand (4) potentially located at the tap (2) in order to control a flow of the water (6) through the channel (22), the ultrasonic transducer (30) is arranged between the channel (22) and a wall portion (36) of the wall (20) inside the main body (8) in a radial direction (34) relative to the course line (18), said wall portion containing at least part of the visible surface (24).

The invention relates to a tap which can be switched without contact when a person brings their hands close to it in order to draw water from the tap, e.g. in order to rinse their hands with water or wash them.

DE-OS 27 21 217 A1 discloses a tap fitting with a water outlet opening and a connection part for connecting the fitting to the water pipe, wherein this fitting includes an electromechanical shut-off mechanism which is controlled by an ultrasonic motion detector with an ultrasonic transmitting transducer and an ultrasonic receiving transducer. The transmitting transducer is also provided as a receiving transducer, wherein the transducer with its transmitting and receiving radiation lobe is directed downwards at an angle β to the outgoing water jet and through the water jet in such a way that, for a sharply directed radiation lobe with the opening angle α, the following applies: β less than 90°-α/2.

JP H04-50 575 A discloses an automatic tap which is equipped with a detection sensor and dispenses water from a water outlet based on detection by the sensor.

DE 691 00 077 T2 discloses a tap fitting having a water flow extending from a region for receiving the supplied water to a region for discharging the water; with a valve disposed in the flow and performing at least one of interrupting or adjusting the flow rate of the water flowing in the flow; and with driver means for operating the valve, wherein an ultrasonic transmitter for emitting an ultrasonic signal controlling the valve and a receiver for receiving said ultrasonic signal are arranged separately from each other; wherein an ultrasonic signal emitted from the transmitter propagates through the flow and is receivable by the receiver, wherein the driver means is controllable by a signal received from the receiver.

The object of the invention is to propose improvements in relation to such a tap.

The problem is solved by a tap according to claim 1. Preferred or advantageous embodiments of the invention and other categories of the invention can be found in the further claims, the following description and the attached figures.

The tap serves or is designed for drawing water from it with the aid of a hand, in particular for rinsing the hand with the water, e.g. for washing hands. The tap is in particular a tap for mounting on a hand wash basin.

The tap contains a main body. The main body has an inlet end. An inlet for water is located at the inlet end. The tap can be connected to a pressurized water pipe via the inlet in order to supply the tap with water.

The main body has an outlet end. There is an outlet for the water at the outlet end. This is where the water comes out of the tap, e.g. to rinse a hand.

The main body extends along a course line from the inlet end to the outlet end.

The main body contains a channel for the water, which runs inside the main body and leads from the inlet to the outlet. The main body has a wall that surrounds the channel. The wall has an outer visible surface or surface of the tap. In other words, at least part of the wall forms at least part of the outer wall/visible surface of the tap.

The tap contains an ultrasonic transducer. This serves or is set up to detect the hand or a hand that is potentially located at the tap. The detection of the hand (or non-detection if there is currently no hand to be detected) is used to control the flow of water through the channel. In other words: If the hand is detected by the ultrasonic transducer, the water flow is released; if no hand is detected, the water flow is blocked.

The ultrasonic transducer is arranged in a radial direction between the channel and a wall portion of the wall inside the main body. The radial direction is related to the course line or its longitudinal direction and runs perpendicular to it at the corresponding location. The wall portion contains at least part of the visible surface, i.e. it is also a wall portion that delimits the tap towards the outside. Consequently, the ultrasonic transducer is not visible from the outside and is located inside the main body, as this is covered by the wall (wall portion). The ultrasonic transducer is therefore hidden inside the body.

This creates a particularly visually appealing tap of which the visible surface is not affected by the ultrasonic transducer. In addition, the ultrasonic transducer inside the tap is well protected, for example against damage, calcification, dirt, etc.

According to the invention, the wall portion is designed with a smaller wall thickness compared to the wall surrounding the wall portion (wall in an environment of the wall portion). The wall portion is therefore thinner than the wall in the vicinity of the wall portion. In other words, the wall at the location of the ultrasonic transducer is thinned out, in particular by milling a cut-out in the wall from the inside. In particular, the thickness of the wall portion is at most 1 mm. This allows ultrasonic signals from the ultrasonic transducer (transmission signal and return signal) to penetrate the wall portion well in order to travel from the ultrasonic transducer to the environment of the tap and from the environment back to the ultrasonic transducer in the tap. The wall portion is therefore penetrated by ultrasonic signals from the ultrasonic transducer during operation of the ultrasonic transducer.

The transmitted signal is the ultrasonic signal emitted by the ultrasonic transducer. The return signal is any back-reflected/back-scattered part of the transmitted signal. Return signals are in particular those parts of the transmitted signals that are back-scattered/back-reflected by the hand. The return signal is therefore caused in particular by a detected and moving hand.

In a preferred embodiment, the ultrasonic transducer lies against an inner side of the wall portion with a coupling element in between. The coupling element is in particular (slightly) elastic, especially a synthetic polymer, and serves to improve the transmission of the ultrasonic waves between the ultrasonic transducer and the environment of the tap, i.e. through the wall portion. This improves the coupling out of the ultrasonic transmission signal and coupling in of the ultrasonic return signal in relation to the tap.

In a preferred embodiment, the ultrasonic transducer has a beam window for ultrasound. The beam window is a spatial region or a solid angle region that extends away from the ultrasonic transducer. In this spatial region, the ultrasonic transducer preferably emits the main part of its transmitted signal and receives any return signal. The beam window thus describes a detection direction/range of the ultrasonic transducer in which it wants to/can detect the hand.

Outside the jet window, the ultrasonic transducer is shielded from at least part of the rest of the tap by acoustic insulation (matched to the ultrasound of the transducer). In other words, the acoustic insulation is arranged around the transducer, wherein in particular only the jet window is left open. This means that ultrasound generated by the ultrasonic transducer cannot or can hardly reach undesirable directions, especially the inside of the tap, for example towards the sewer. The same applies to the coupling of the return signal or any interference signals from undesired directions, i.e. from directions outside the radiation window.

In a preferred embodiment, the tap contains a control unit that is assigned to the ultrasonic transducer or is electrically connected to it. The control unit is set up to carry out hand detection (hand detection algorithm/method) using the return signal received from the ultrasonic transducer. This means that no components external to the tap are required to carry out the hand detection. The detection is successful because the return signals are different depending on the different scenarios (hand near the tap or not/hand being moved or not) and can be analysed accordingly by the control unit in the usual way.

In a preferred variant of this embodiment, the control unit is set up to first filter out a constant signal from the return signal, i.e. to remove this or a DC component from the return signal. The remaining return signal remains in the form of an (offset-free/DC component-free) alternating signal. The control unit is set up to carry out the hand detection using the remaining return signal in the form of the temporal alternating signal.

The control unit/hand detection (algorithm) is also set up to detect the hand only at such a rate of change (amplitude) of the change signal if the rate of change exceeds a threshold value. In particular, the threshold value can be selected/changed. This makes it possible in particular to filter out or ignore interfering influences from the return signal that could otherwise lead to false detection of the presence or absence of a hand.

In a preferred variant of this embodiment, the hand detection has at least one delay time and/or at least one hysteresis in relation to the rate of change exceeding and/or falling below the threshold value. In this way, short-term disturbances in the return signal or false detections or too frequent/incorrect switching on and off of the water flow by the tap can be avoided.

The delay time and/or hysteresis can also be changed/selected here, e.g. to compensate for the conditions of the environment, for example a special size or shape of a washbasin on which the tap is mounted, or to incorporate them into the hand detection.

In a preferred embodiment, the wall of the tap is made of a metal material and/or plastic material. This provides a wide range of options for designing the tap, particularly with regard to its outer surface/visible surface.

In a preferred embodiment, the main body has a flat planar portion at least on the wall portion, i.e. in the region of the ultrasonic transducer. This means that the visible surface is also flat there. The planar portion is therefore located in the region of the ultrasonic transducer and is the portion of the wall and visible surface through which the transmission/return signal passes during operation. This makes it particularly easy to attach the ultrasonic transducer to the wall portion/planar portion, i.e. to a flat wall portion, with good sound coupling properties.

In a preferred variant of this embodiment, the main body has a body portion along the course line. The body portion is at least large enough to have/contain the planar portion. In relation to the course line, the body portion has an at least bi-angular (bi-angular: in particular semi-circular) cross-section, with the planar portion extending between two of the corners. The main body is in particular triangular, quadrangular, polygonal or semi-circular. The angular cross-section creates a flat surface at least between two corners or edges, which then contains/forms the planar portion. This makes the ultrasonic transducer particularly easy to integrate into the tap.

The invention is based on the following findings, observations and considerations and also has the following preferred embodiments. These embodiments are sometimes also referred to as “the invention” for the sake of simplicity. The embodiments may also include or correspond to parts or combinations of the above-mentioned embodiments and/or may also include previously unmentioned embodiments.

According to the invention, the result is a so-called contactless tap.

The result is an ultrasonic-based detection mechanism for fittings (taps), which are primarily intended for use in public sanitary facilities. The sensor is not visually recognizable from the outside. In addition, the software control (control unit) is adapted in particular so that as little water as possible is wasted.

The invention is based on the realization that the detection mechanism in existing fittings is usually implemented using infrared light. When an object is detected in the area of the washbasin, the water flow is then activated for a fixed interval of X seconds, which often ensures that the water continues to flow for a few seconds after the hands have been removed.

Such contactless taps therefore always have a small black window in the “base” or “anchor” of the tap. This is necessary so that the infrared light can penetrate to the outside.

On the one hand, the invention solves the problem of a possible break in aesthetics by installing the black glass device; on the other hand, water consumption in particular is minimized by revising the classic algorithms (hand detection according to the invention). Instead of letting the water flow run continuously for a fixed interval during detection, the water flow according to the invention is in particular only active (incl. small dead time) when there is a rate of change due to the movement of the hands in the washing process.

According to the invention:
Sensor not visible from outside.
No detection errors due to different skin colours.
No detection errors due to ambient light.
No detection errors due to soiling of the glass for the infrared light.
Reduced water consumption due to customized algorithms.

A basic idea of the invention is the use of ultrasound for presence detection, particularly in public fittings, as well as the integration of the measuring device (ultrasonic transducer), which is not visible from the outside.

The invention can be used in particular:
1) Use in the touchless lavatory of an aircraft cabin.
2) Use in all other public sanitary facilities.

According to the invention, the result is an innovative technology for taps based on ultrasound that offers a non-visible solution to the problems of variable sensitivity and delayed response time of conventional infrared-based systems. In addition, the product leaves a positive impression as the sensor is not visible to the user.

High-frequency (inaudible) sound waves are used to detect hands or objects in the washbasin region. The use of ultrasonic waves also minimizes potential interference from ambient light or other light sources. The invention promises a more efficient and user-friendly experience, especially in public bathrooms and other sanitary facilities.

The invention is based on the following observations:

They can be found everywhere and in times of increased hygiene awareness, it is hard to imagine life without them: contactless taps that use “Time of Flight” (ToF) processes to detect the presence of hands and control the valve to the water pipe based on this signal. Commercially available systems use a light signal in the infrared spectrum to detect obstacles.

However, this approach has some disadvantages:
External factors such as sunlight, reflections or other light sources in the environment can lead to detection errors.
Many systems have different sensitivities to different skin types, so the system may not react at all.
Deposits of limescale and dirt on the glass housing of the sensor can adversely affect the sensor performance.
In many systems, there is a noticeable delay between the point at which the hands are held under the tap and the start of the water flow. The same applies to removing the hands, wherein the water often continues to flow for a few seconds. This results in large amounts of water being spilt.

In addition, the optical sensor is visible to the naked eye in most designs, which may not be to the aesthetic liking of every user. Especially in regions with a focus on aesthetics or design, a concealed implementation of the sensor would be desirable.

All of the above problems can be solved by the invention. In particular, this provides for the realization of hand detection with the aid of a high-frequency ultrasonic sensor, which is mounted frontally in the “anchor” of the tap on the inside and transmits the sound waves to the outside, in particular via a coupling element through the housing. The proposed system is suitable for both plastic fittings and metal fittings.

The core of the invention is in particular an ultrasonic transducer element, which is positioned on the inside of the tap in the direction of the washbasin. Between the transducer and the fitting (metal/plastic), a slightly elastic coupling material, in particular made of a synthetic polymer such as silicone, is introduced in order to improve the transmission of the sound waves from the transducer to the fitting. At the point where the sensor is applied, the wall of the tap should be particularly thin, especially due to milling-including coatings, the wall thickness at this point should not exceed one millimetre. A sound-absorbing acoustic foam, particularly made of polyurethane, is fixed around the transducer element to damp the sound waves travelling to the sides and back. As a result, the acoustic energy is not dissipated significantly further via the water pipes.

The transducer emits a continuous, high-frequency sound wave with a high amplitude, which is passed on to the fitting via the coupling element. Due to the particularly thin wall thickness at this point, the tap can transport the longitudinal wave further outwards into the region of the washbasin. Depending on the presence of a hand or other object in the washbasin region, the sound waves are reflected and absorbed to varying degrees. The return signal received by the transducer then has a different signal pattern in the different scenarios, which is used to detect an object in front of the tap.

However, when the valve is switched and the water flows into the washbasin, a different scenario arises of its own accord, in which the water jet would cause an unwanted signal change. To prevent this from happening, the integrated control electronics must adjust the sensitivity of the sensor in the event of water flow. An even more precise and faster approach here is the filtering of the constant signal (DC) and the associated evaluation of the pure alternating signal (AC). In particular, the control electronics should only open the valve if the rate of change of the return signal is sufficient. As the hands are usually moved during the washing process, the valve would remain open in this case. However, as soon as the rate of change no longer exceeds a certain threshold value, the water flow would be stopped immediately. The threshold value must be set individually. With the right parameter, the valve can be closed with a very short time delay, which would save considerable amounts of water over a long period of time.

An artificial delay time or hysteresis is built in so that the system does not react too quickly, leading to misinterpretations. Exceeding the threshold value is therefore also linked to a time component in particular.

To simplify the integration of the ultrasonic sensor including control electronics inside the fitting and to keep the general manufacturing process simple, a square or rectangular shape of the tap in the region of the anchor is particularly recommended.

Depending on the design of existing fittings, the technology is also suitable for retrofitting. Of course, the system can also be installed in narrower or differently shaped fittings.

Further features, effects and advantages of the invention are shown in the following description of a preferred exemplary embodiment of the invention and in the accompanying figures. The figures show, in each case in a schematic principle sketch:

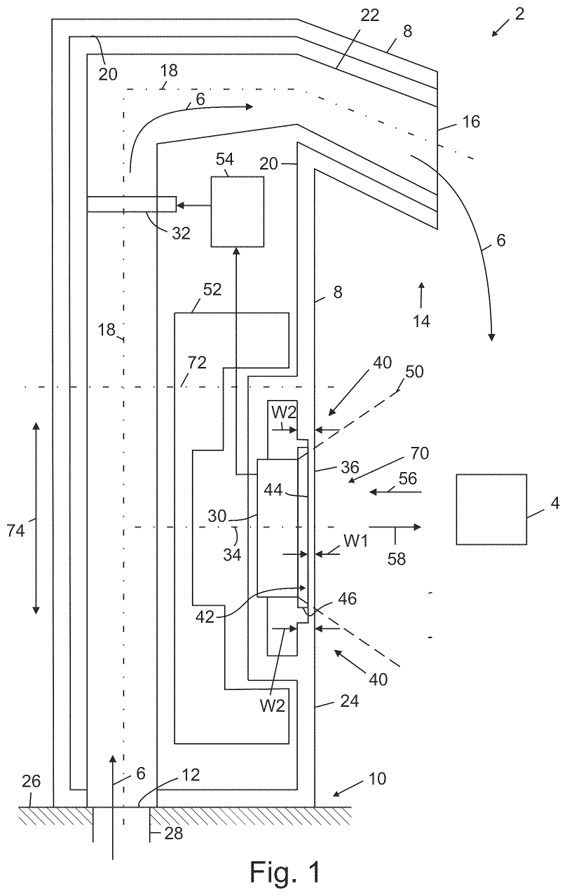

FIG. 1 a cross-section of a tap (fitting) in conceptual representation,

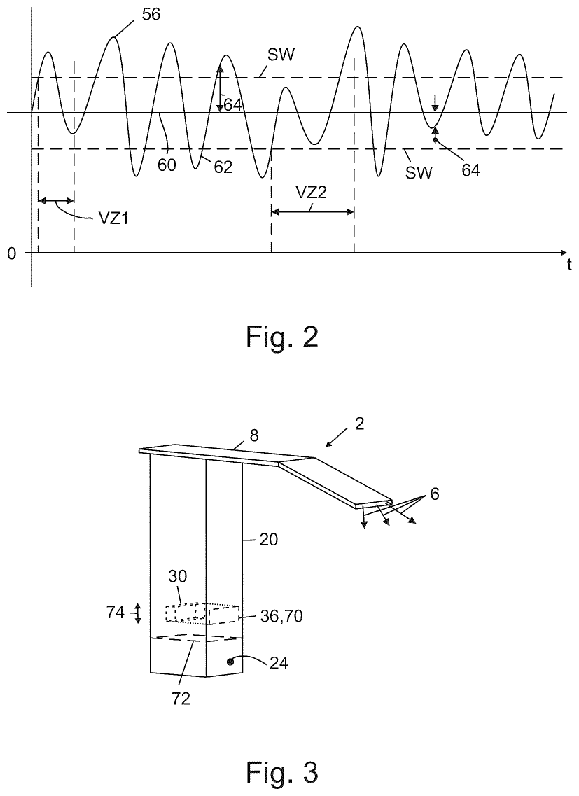

FIG. 2 a schematic representation of the received signal (return signal),

FIG. 3 a tap as design inspiration in perspective view.

FIG. 1 shows a tap 2, with the aid of which a person (not shown further) washes their hand 4 with water 6. To do this, they hold their hand 4 in the immediate vicinity 3 of the tap 2, namely in or over a hand washbasin 26 on which the tap 2 is mounted. The water 6 or its direction of flow is indicated in the figure by flow arrows.

The tap 2 contains a main body 8, in this case made of metal. The main body 8 has an inlet end 10. With the inlet end, the main body 8 and thus the entire tap 2 is mechanically mounted/attached to the washbasin 26. An inlet 12 for the water 6 is provided at the inlet end 10 and is connected to a supply line for water 6, i.e. a water pipe 28 under water pressure.

The main body 8 has an outlet end 14 opposite the inlet end 10. This outlet end has an outlet 16 for the water 6.

The main body 8 thus extends along a course line 18 of the main body 8 from the inlet end 10 to the outlet end 14. The main body 8 has a wall 20. A channel 22 runs inside the main body 8 and leads from the inlet 12 to the outlet 16 and serves to guide the water 6. The wall 20 surrounds the channel 22.

The main body 8 or its wall 20 has an outer visible surface 24, which therefore forms the outer surface of the tap 2. The wall 20 or the entire main body 8 is made here of metal material.

The tap 2 contains an ultrasonic transducer 30. This is used to detect the hand 4 potentially located on the tap 2. Ultimately, the detection is used to control the flow of water 6 through the channel 22, i.e. to release or block it. This is done here with a valve 32 placed in the channel 22 or acting on it, which is controlled with the aid of the ultrasonic transducer 30 or its sensor signal, which is not explained in more detail.

With regard to a radial direction 34 related to the course line 18, the ultrasonic transducer 30 is arranged between the channel 22 and a wall portion 36 of the wall 20, wherein the wall portion 36 has the visible surface 24. The ultrasonic transducer 30 is therefore arranged inside the main body 8. The ultrasonic transducer 30 is mechanically fixed or mounted in the tap 2 or on the main body 8 with the aid of fixing struts 38, which are not explained in more detail and are in turn attached to the main body 8 or the wall 20.

The wall portion 36 is designed with a wall thickness W1 of 1 mm in the region of the ultrasonic transducer 30. Compared to the wall 20 in an environment 40 of the wall portion 36, it is thinner. In the environment 40, the wall thickness W2 is 3 mm. The reduction of the wall thickness W1 compared to that W2 in the environment 20 is achieved by the wall 20 having a milled cut-out 42 at the relevant point from the inside, i.e. from the inside of the main body 8 or tap 2.

The ultrasonic transducer 30 lies against an inner side 44 of the wall portion 36 with a coupling element 46 in between in order to improve the sound transmission between the ultrasonic transducer 30 and the environment 3 in both directions.

The ultrasonic transducer 30 has a beam window 50 for ultrasound, which is indicated here by dashed lines and occupies a roughly conical spatial region. Outside the beam window 50, the ultrasonic transducer 30 is shielded from the rest of the tap 2 by acoustic insulation 52. During operation, the ultrasonic transducer 30 emits a transmission signal 58 in the form of ultrasound within the beam window 50. The ultrasound is back-reflected/back-scattered by items/objects in the environment 3, in particular when the hand 4 is present. Part of the back-reflected/back-scattered transmission signal 58 forms a return signal 56, which is received by the ultrasonic transducer 30 within the beam window 50.

FIG. 2 shows schematically and qualitatively the principle progression of the or an exemplary return signal 56 over time t. The return signal 56 has a constant component, represented by a constant signal 60. It also has an alternating component as alternating signal 62, which is formed by the difference between the return signal 56 and the constant signal 60 and thus has positive and negative values (constant signal 60 as an imaginary zero line for the alternating signal 62).

The tap 2 contains a control unit 54, which is associated with the ultrasonic transducer 30, in this case electrically connected to it. The control unit 54 is thus set up to carry out hand recognition (recognition of the hand 4) using the return signal 56 received from the ultrasonic transducer, if applicable.

The control unit 54 is set up to first filter out, i.e. eliminate, the constant signal 60 from the return signal 56. This leaves only a “residual” return signal 56 in the form of the alternating time signal 62.

The hand detection is then set up to detect the hand 4 only if a rate of change 64 (amplitude of the alternating signal 62, related in the figure to the constant signal 60 as a zero line) exceeds a threshold value SW.

A delay time VZ1 is provided in the hand detection. In other words, this contains the delay time VZ1 in relation to exceeding the threshold value SW. In the example in FIG. 2, this means that once the threshold value SW has been exceeded, the hand 4 is not recognized until the delay time VZ1 has elapsed. The hand detection contains a second delay time VZ2: After falling below the threshold value SW and only after the delay time VZ2 has elapsed, the hand is no longer detected, which is not the case here.

In other words, a hysteresis is thus realized with regard to exceeding and falling below the threshold value SW.

FIG. 3 shows a perspective and more detailed view of the tap 2 from FIG. 1. The position of the ultrasonic transducer 30 inside the main body 8 or tap 2, which is not visible from the outside (view of the surface or visible surface 24 of the tap 2/main body 8), is shown as a dashed line. For clarity, the ultrasonic transducer 30 is set particularly far back from the visible surface 24.

The visible surface 24 has a planar portion 70 of the visible surface 24 at the wall portion 36, under which or behind which the ultrasonic transducer 30 is located. In other words, the visible surface 24 is flat in the planar portion 70. This is achieved here as follows:

The wall portion 36 is supported by a body portion 74 of the main body 8 or the latter has the wall portion 36. At the body portion 74 and thus at the wall portion 36, the main body 8 has an angular, here rectangular cross-section 72. Part of the cross-section (namely here the flat “front side”) of the main body 8 has the planar portion 70.

### LIST OF REFERENCE SIGNS

2 tap
3 environment (tap)
4 hand
6 water
8 main body
10 inlet end
12 inlet
14 outlet end
16 outlet
18 course line
20 wall
22 channel
24 visible surface
26 washbasin
28 water pipe
30 ultrasonic transducer
32 valve
34 radial direction
36 wall portion
38 fixing strut
40 environment (wall portion)
42 milled cut-out
44 inner side
46 coupling element
50 beam window
52 acoustic insulation
54 control unit
56 return signal
58 transmission signal
60 constant signal
62 alternating signal
64 rate of change
70 planar portion
72 cross-section
74 body portion
SW threshold value
VZ1,2 delay time
W1,2 wall thickness
t time

1. A tap for drawing water therefrom with the aid of a hand,
with a main body,
wherein the main body has an inlet end with an inlet for the water,
and an outlet end with an outlet for the water,
and extends along a course line from the inlet end to the outlet end,
wherein the main body has a wall which surrounds a channel for the water extending inside the main body and leading from the inlet to the outlet,
wherein the wall has an outer visible surface of the tap,
with an ultrasonic transducer for detecting the hand potentially located at the tap in order to control a flow of water through the channel,
wherein the ultrasonic transducer is arranged between the channel and a wall portion of the wall inside the main body in a radial direction relative to the course line, said wall portion containing at least part of the visible surface,
wherein the wall portion is penetrated by ultrasonic signals of the ultrasonic transducer during operation of the ultrasonic transducer,
wherein the wall portion in the region of the ultrasonic transducer is designed with a smaller wall thickness compared to the wall in an environment of the wall portion.

2. The tap according to claim 1, wherein the ultrasonic transducer rests against an inner side of the wall portion with a coupling element in between.

3. The tap according to claim 1, wherein the ultrasonic transducer has a beam window for ultrasound and the ultrasonic transducer is shielded outside the beam window from at least part of the rest of the tap by acoustic insulation.

4. The tap according to claim 1, wherein the tap contains a control unit associated with the ultrasonic transducer, which is set up to carry out hand detection on the basis of a return signal received from the ultrasonic transducer.

5. The tap according to claim 4, wherein the control unit is set up to first filter out a constant signal from the return signal and to carry out the hand detection using the remaining residual return signal in the form of an alternating signal, wherein the hand detection is set up to detect the hand only at a rate of change of the alternating signal which exceeds a threshold value (SW).

6. The tap according to claim 5, wherein the hand detection has at least one delay time (VZ1, 2) and/or at least one hysteresis in relation to the rate of change exceeding and/or falling below the threshold value (SW).

7. The tap according to claim 1, wherein the wall is made of a metal and/or plastic material.

8. The tap according to claim 1, wherein the main body has a flat planar portion of the visible surface at least on the wall portion.

9. The tap according to claim 8, wherein the main body has a body portion having the planar portion along the course line, wherein the body portion has an at least bi-angular cross-section with respect to the course line, wherein the planar portion extends between two of the corners.
